(19) United States
(12) Patent Application Publication
(10) Pub. No.: US 2008/0152901 A1
(43) Pub. Date: Jun. 26, 2008

(54) Nanostructure optical insulating membrane

(75) Inventors: Chia-Jen Ting, Hsinchu (TW); Chin-Ju Hsu, Hsinchu (TW); Ya-Yu Nieh, Hsinchu (TW); Chang-Pin Chou, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/898,618

(22) Filed: Sep. 13, 2007

(30) Foreign Application Priority Data
Dec. 21, 2006 (TW) 095148117

(51) Int. Cl. B32B 5/14; B23B 9/00; B32B 17/06

(52) U.S. Cl. 428/328; 428/332; 428/339; 977/811

(57) ABSTRACT

A nano-structure optical insulating membrane includes a substrate, a nano-structure layer formed on the substrate, and a metal layer formed on the nano-structure layer is disclosed. Upon exposure to light, the nano-structure layer increases visible light transmission but reduces internal reflection, and the metal layer blocks infrared light and thereby provides thermal insulation. The nano-structure optical insulating membrane of the present invention enhances illumination, spares lighting equipment, saves energy, and enables users to see farther.

### BACKGROUND OF THE INVENTION

1. Field of the Invention

The present invention relates to nanostructure optical insulating membranes, and more particularly, to a nanostructure optical insulating membrane adapted to provide thermal insulation, enhance illumination, spare lighting equipment, and enable users to see farther.

2. Description of the Prior Art

Insulating membranes are typically used in vehicles and buildings to block UV light and infrared light. Insulating membranes not only block incoming light rays which may harm the human body and damage furniture/fixtures, but also decrease indoor temperature which can otherwise increase because of exposure to unblocked sunlight, thereby making insulating membranes a good energy-saving means.

Insulating membranes currently available on the market block more than 99% of UV light and 35% to 97% of infrared light. An insulating membrane fabrication process is usually based on multi-coating technology, producing optical products with coats numbered in the dozens or even totaling to a hundred. Hence, the fabrication process is complex and expensive. More badly, an insulating membrane that comprises one or more metal layers decreases visible light transmission to 20-70%, which is an inevitable drawback of the prior art.

A building equipped with insulating membranes is disadvantaged by poor illumination and excessive internal reflection. Owing to insulating membrane-induced internal reflection, people looking out of a window of the building cannot have a clear view of the outside, that is, they are unable to see farther. The driver of a vehicle equipped with insulating membranes is denied access to images in rear view mirrors and therefore likely to end up in a traffic accident.

Accordingly, an issue calling for an immediate solution involves developing a nanostructure optical insulating membrane that overcomes the aforesaid drawbacks of the prior art.

### SUMMARY OF THE INVENTION

It is a primary objective of the present invention to disclose a nanostructure optical insulating membrane adapted to provide thermal insulation, enhance illumination, and enable users to see farther.

The present invention discloses a nanostructure optical insulating membrane, comprising: a substrate; a nanostructure layer formed on the substrate to increase visible light transmission and decrease internal reflection upon exposure to light; and a metal layer formed on the nanostructure layer to block infrared light upon exposure to light and thereby provide thermal insulation.

In a preferred embodiment, the substrate and the nanostructure layer of the nanostructure optical insulating membrane of the present invention are made of transparent polymeric plastics, such as PC, PMMA, and PET. The nano structure layer is formed on the substrate by UV curing or hot embossing and comprised of a plurality of nano-structured three-dimensional cones aligned periodically or non-periodically. Each of the nano-structured three-dimensional cones is 100 nm to 600 nm wide and 100 nm to 750 nm high. The metal layer is gold, silver, aluminum, nickel, copper, chromium, tin oxide, or indium tin oxide (ITO) and has a thickness of 150 nm or less. The nanostructure optical insulating membrane further comprises a protective layer formed on the metal layer to protect the metal layer and the nanostructure layer. The protective layer, which is a hard coat, is formed on the metal layer by electroplating and made of silicon dioxide (SiO₂).

Unlike the prior art, the prevent invention discloses a nanostructure optical insulating membrane that, upon exposure to light, enhances visible light transmission, reduces internal reflection, provides thermal insulation by blocking infrared light by means of a metal layer, and enables users to see farther.

### BRIEF DESCRIPTION OF THE DRAWINGS

FIG. 1 is a cross-sectional view showing the first embodiment of a portion of a nanostructure optical insulating membrane of the present invention;

FIG. 2 is a cross-sectional view showing the second embodiment of a portion of a nanostructure optical insulating membrane of the present invention;

FIG. 3 shows a graph of light transmission against wavelength for visible light by experiment;

FIG. 4 is a table showing calculated average light transmission of visible light (380 nm˜780 nm) based on FIG. 3;

FIG. 5 shows a graph of internal reflection against wavelength for visible light by experiment;

FIG. 6 is a table showing calculated average internal reflection of visible light (380 nm˜780 nm) based on FIG. 5;

FIG. 7 shows a graph of reflection against wavelength for infrared light by experiment; and

FIG. 8 is a table showing calculated average reflection of infrared light (780 nm˜2200 nm) based on FIG. 7.

### DETAILED DESCRIPTION OF THE PREFERRED EMBODIMENTS

The following specific embodiments are provided to illustrate the present invention. Persons skilled in the art can readily gain an insight into other advantages and features of the present invention based on the contents disclosed in this specification.

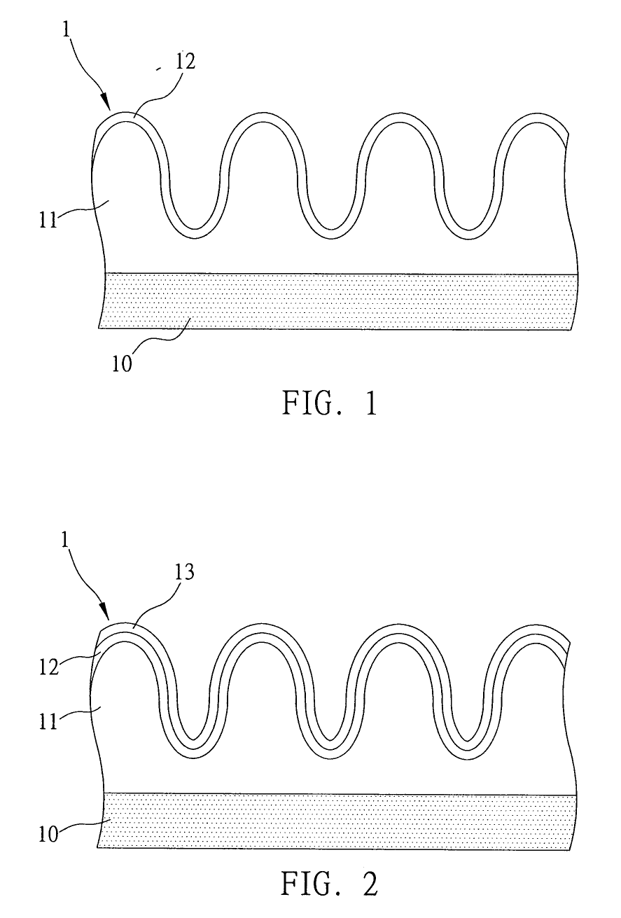

Referring to FIG. 1, which is a cross-sectional view showing the first embodiment of a portion of a nanostructure optical insulating membrane of the present invention, a nanostructure optical insulating membrane 1 is used in any venues that need thermal insulation, such as indoor environments and vehicles. As shown in the drawing, the nanostructure optical insulating membrane 1 comprises a substrate 10, a nanostructure layer 11, and a metal layer 12.

The constituent parts of the nanostructure optical insulating membrane 1 of the present invention are described in detail as follows.

The drawing illustrates the substrate 10 but is not intended to limit the dimensions of the substrate 10. In practice, the dimensions the substrate 10 are selectively designed when necessary. In this embodiment, the substrate 10 is made of transparent polymeric plastics, such as PC, PMMA, and PET.

The nanostructure layer 11 is formed on the substrate 10 such that the nanostructure optical insulating membrane 1, upon exposure to light, increases visible light transmission, decreases internal reflection, and allows users to see farther.

In this embodiment, the nanostructure layer 11 is made of transparent polymeric plastics, Such as PC, PMMA, and PET and is formed on the substrate 10 by, preferably, hot embossing. Preferably, both the nanostructure layer 11 and the substrate 10 are made of the same material. For instance, both the nanostructure layer 11 and the substrate 10 are made of PET; or, alternatively, both the nanostructure layer 11 and the substrate 10 are made of PMMA.

In another preferred embodiment, the nanostructure layer 11 is formed on the substrate 10 by UV curing. Where the substrate 10 is made of PET, the nanostructure layer 11 is preferably made of a polymer susceptible to UV curing.

The nanostructure layer 11 comprises a plurality of nanostructured three-dimensional cones aligned periodically or non-periodically. Each of the nanostructured three-dimensional cones has a width (W) of 100 nm, 600 nm, or between 100 nm and 600 nm (i.e., 100 nm≦W≦600 nm), and a height (H) of 100 nm, 750 nm, or between 100 nm and 750 nm (i.e., 100 mm≦H≦750 nm). As shown in the drawing, the nanostructured three-dimensional cones of this embodiment are aligned periodically, though the way of aligning the nanostructured three-dimensional cones is not limited to the aforesaid disclosure.

The metal layer 12 is formed on the nanostructure layer 11 such that the nanostructure optical insulating membrane 1, upon exposure to light, blocks infrared light and provides thermal insulation. In this embodiment 4 the metal layer 12 is gold, silver, aluminum, nickel, copper, chromium, tin oxide, or indium tin oxide (ITO) and has a thickness of 150 nm or less.

Referring to FIG. 2, which is a cross-sectional view showing the second embodiment of a portion of a nanostructure optical insulating membrane of the present invention. The second embodiment differs from the first embodiment in the way that the second embodiment discloses that the nanostructure optical insulating membrane 1 further comprises a protective layer 13 formed on the metal layer 12 to protect the metal layer 12 and the nanostructure layer 11. The protective layer 13 not only reinforces the structural strength of the nanostructure optical insulating membrane 1 but also protects the metal layer 12 and the nanostructure layer 11 against damage caused by a scrub (for example, during cleaning) or an intruding foreign body (for example, dust). In other words, a user can scrub the nanostructure optical insulating membrane 1 in the presence of the protective layer 13 without causing damage to the nanostructure optical insulating membrane 1.

In this embodiment, the protective layer 13 is formed, in the form of a hard coat, on the metal layer 12 by electroplating and is made of silicon dioxide (SiO₂).

Accordingly, the present invention discloses a nanostructure optical insulating membrane 1 for increasing visible light transmission and illumination of vehicles to a great extent, decreasing internal reflection inside the vehicles, allowing drivers to gain access to images in rear view mirrors (that is, to see backward farther while driving), and providing thermal insulation.

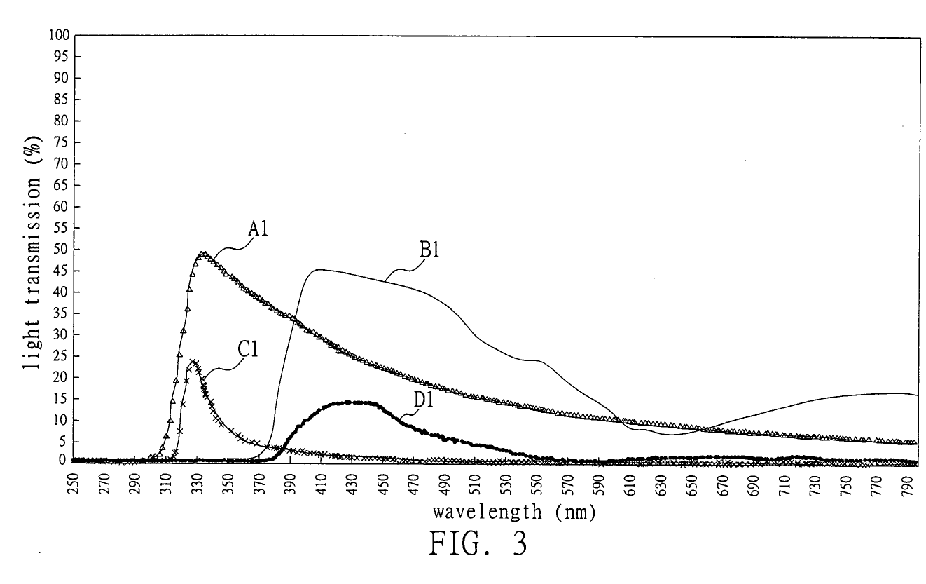

Efficacy of a nanostructure optical insulating membrane of the present invention is illustrated with the following experimental findings. Referring to FIG. 3, which shows a graph of light transmission against wavelength for visible light by experiment, for curves A1, B1, C1, and D1. Curve A1 represents an insulating membrane with a substrate made from a commercially available transparent PET film (200 μm thick) and formed with a 50 nm-thick silver-based (Ag-based) metal layer thereon. Curve B1 represents a nanostructure optical insulating membrane of the present invention with a substrate made from a commercially available transparent PET film (200 μm thick), wherein a nanostructure layer (200 nm˜300 nm in period, and 200 nm˜300 nm in height) disclosed in the present invention is formed on the substrate, and a 50 nm-thick silver-based (Ag-based) metal layer is formed on the nanostructure layer. Curve C1 represents an insulating membrane with a substrate made from a commercially available transparent PET film (200 μm thick) and formed with a 75 nm-thick silver-based (Ag-based) metal layer thereon. Curve D1 represents a nanostructure optical insulating membrane of the present invention with a substrate made from a commercially available transparent PET film (200 μm thick), wherein a nanostructure layer (200 nm˜300 nm in period, and 200 nm˜300 nm in height) disclosed in the present invention is formed on the substrate, and a 75 nm-thick silver-based (Ag-based) metal layer is formed on the nanostructure layer.

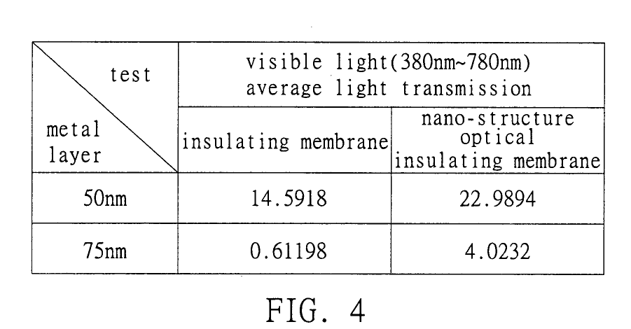

Referring to FIG. 4, which is a table showing calculated average light transmission of visible light (380 nm˜780 nm) based on FIG. 3, the average light transmission of a nanostructure optical insulating membrane (with a metal layer 50 nm or 75 nm thick) of the present invention is greater than that of an insulating membrane lacking a nanostructure layer, proving that the nanostructure optical insulating membrane of the present invention increases transmission of visible light by means of a nanostructure layer.

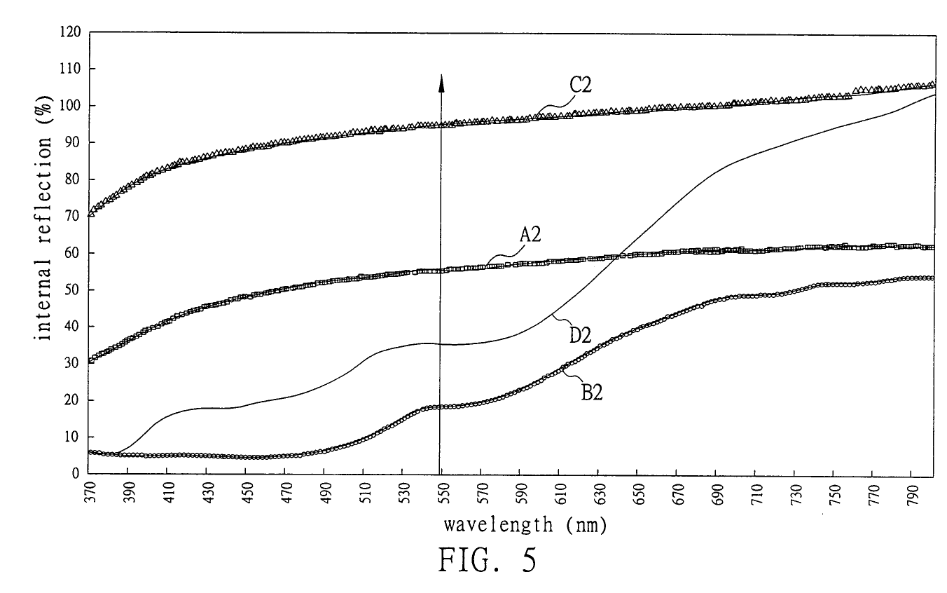

Referring to FIG. 5, which shows a graph of internal reflection against wavelength for visible light by experiment, for curves A2, B2, C2, and D2. Curve A2 represents an insulating membrane with a substrate made from a commercially available transparent PET film (200 nm thick) and formed with a 50 nm-thick silver-based (Ag-based) metal layer thereon. Curve B2 represents a nanostructure optical insulating membrane of the present invention with a substrate made from a commercially available transparent PET film (200 μm thick), wherein a nanostructure layer (200 nm˜300 nm in period, and 200 nm˜300 μm in height) disclosed in the present invention is formed on the substrate, and a 200 nm-thick silver-based (Ag-based) metal layer is formed on the nanostructure layer. Curve C2 represents an insulating membrane with a substrate made from a commercially available transparent PET film (200 μm thick) and formed with a 75 nm-thick silver-based (Ag-based) metal layer thereon. Curve D2 represents a nanostructure optical insulating membrane of the present invention with a substrate made from a commercially available transparent PET film (200 μm thick), wherein a nanostructure layer (200 nm˜300 nm in period, and 200 nm˜300 nm in height) disclosed in the present invention is formed on the substrate, and a 75 mm-thick silver-based (Ag-based) metal layer is formed on the nanostructure layer.

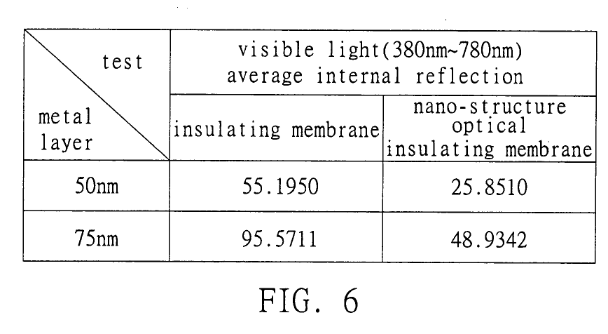

Referring to FIG. 6, which is a table showing calculated average internal reflection of visible light (380 nm˜780 nm) based on FIG. 5, the average internal reflection of a nanostructure optical insulating membrane (with a metal layer 50 nm or 75 nm thick) of the present invention is less than that of an insulating membrane lacking a nanostructure layer, proving that the nanostructure optical insulating membrane of the present invention decreases internal reflection by means of a nanostructure layer.

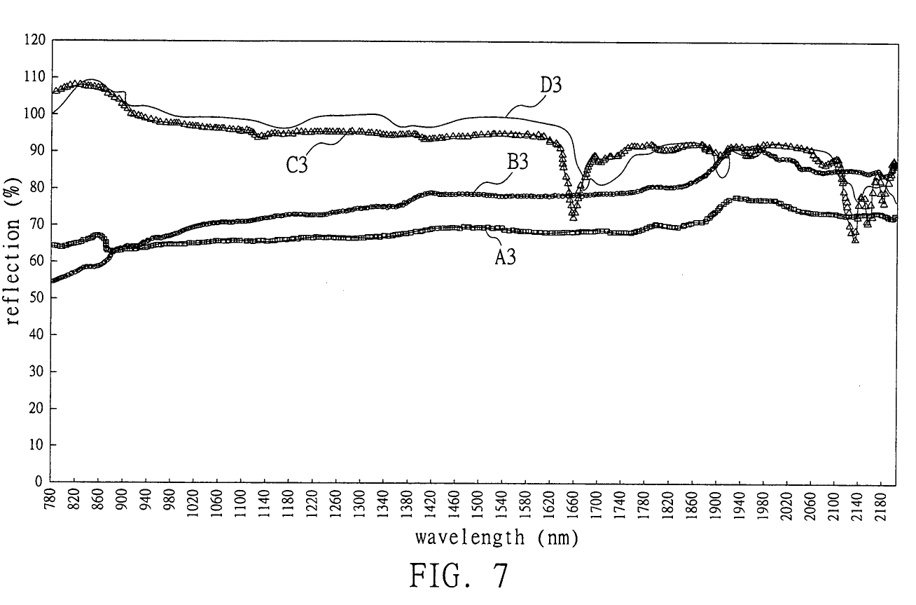

Referring to FIG. 7, which shows a graph of reflection against wavelength for infrared light by experiment, for curves A3, B3, C3, and D3. Curve A3 represents an insulating membrane with a substrate made from a commercially available transparent PET film (200 μm thick) and formed with a 50 nm-thick silver-based (Ag-based) metal layer thereon. Curve B3 represents a nanostructure optical insulating membrane of the present invention with a substrate made from a commercially available transparent PET film (200 μm thick), wherein a nanostructure layer (200 nm˜300 nm in period, and 200 nm˜300 nm in height) disclosed in the present invention is formed on the substrate, and a 50 nm-thick silver-based (Ag-based) metal layer is formed on the nanostruclure layer. Curve C3 represents an insulating membrane with a substrate made from a commercially available transparent PET film (200 μm thick) and formed with a 75 nm-thick silver-based (Ag-based) metal layer thereon. Curve D3 represents a nanostructure optical insulating membrane of the present invention with a substrate made from a commercially available transparent PET film (200 μm thick), wherein a nanostructure layer (200 nm˜300 nm in period, and 200 nm˜300 nm in height) disclosed in the present invention is formed on the substrate, and a 75 nm-thick silver-based (Ag-based) metal layer is formed on the nanostructure layer.

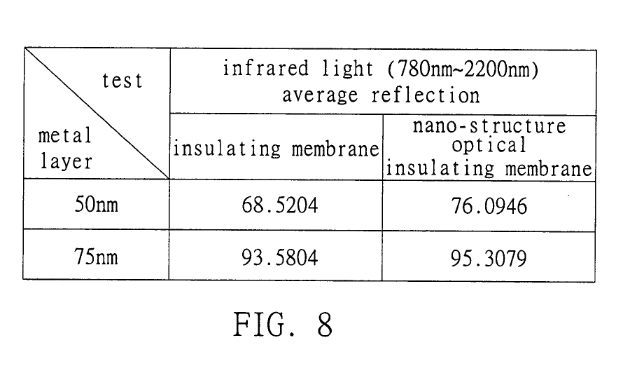

Referring to FIG. 8, which is a table showing calculated average reflection of infrared light (780 nm˜2200 nm) based on FIG. 7, the average reflection of a nanostructure optical insulating membrane (with a metal layer 50 nm or 75 nm thick) of the present invention is greater than that of an insulating membrane lacking a nanostructure layer, proving that the nanostructure optical insulating membrane of the present invention increases reflection of infrared light by means of a nanostructure layer, thus blocking infrared light better.

In short, the present invention discloses a nanostructure optical insulating membrane that, upon exposure to light, enhances visible light transmission, reduces internal reflection, provides thermal insulation by blocking infrared light by means of a metal layer, and enables users to see farther.

The aforesaid embodiments merely serve as the preferred embodiments of the present invention. The aforesaid embodiments should not be construed as to limit the scope of the present invention in any way. Hence, any other changes can actually be made in the present invention. It will be apparent to those skilled in the art that au equivalent modifications or changes made to the present invention, without departing from the spirit and the technical concepts disclosed by the present invention, should fall within the scope of the appended claims.

What is claimed is:

1. A nanostructure optical insulating membrane, comprising:
a substrate;
a nanostructure layer formed on the substrate to increase visible light transmission and decrease internal reflection upon exposure to light; and
a metal layer formed on the nanostructure layer to block infrared light upon exposure to light and thereby provide thermal insulation.

2. The nanostructure optical insulating membrane of claim 1, wherein the substrate and the nanostructure layer are made of a transparent polymer.

3. The nanostructure optical insulating membrane of claim 1, wherein the nanostructure layer is formed on the substrate by coated with a UV glue and then undergoes UV curing.

4. The nanostructure optical insulating membrane of claim 1, wherein the nanostructure layer is formed on the substrate by hot embossing.

5. The nanostructure optical insulating membrane of claim 2, wherein the substrate and the nanostructure layer are made of one selected from the group consisting of PMMA, PC, and PET.

6. The nanostructure optical insulating membrane of claim 1, wherein the nanostructure layer comprises a plurality of nanostructured three-dimensional cones.

7. The nanostructure optical insulating membrane of claim 6, wherein the nanostructured three-dimensional cones are aligned periodically.

8. The nanostructure optical insulating membrane of claim 7, wherein each of the nanostructured three-dimensional cones has a width ranging from 100 nm to 600 nm and a height ranging from 100 nm to 750 nm.

9. The nanostructure optical insulating membrane of claim 6, wherein the nanostructured three-dimensional cones are aligned non-periodically.

10. The nanostructure optical insulating membrane of claim 9, wherein each of the nanostructured three-dimensional cones has a width ranging from 100 nm to 600 nm and a height ranging from 100 nm to 750 nm.

11. The nanostructure optical insulating membrane of claim 1, wherein the metal layer is made of one selected from the group consisting of gold, silver, aluminum, nickel, copper, chromium, tin oxide, and indium tin oxide (ITO).

12. The nanostructure optical insulating membrane of claim 11, wherein thickness of the metal layer is not greater than 150 nm.

13. The nanostructure optical insulating membrane of claim 1, further comprising a protective layer formed on the metal layer.

14. The nanostructure optical insulating membrane of claim 13, wherein the protective layer is formed on the metal layer by electroplating.

15. The nanostructure optical insulating membrane of claim 14, wherein the protective layer is a hard coat.

16. The nanostructure optical insulating membrane of claim 15, wherein the hard coat is made of silicon dioxide (SiO₂).
